(19) United States
(12) Patent Application Publication
(10) Pub. No.: US 2017/0209720 A1
(43) Pub. Date: Jul. 27, 2017

(54) WASHABLE FABRIC FACE MASK WITH A COMPARTMENT FOR AN AIR FILTER

(71) Applicant: Michael Mingo, Buffalo, NY (US)

(72) Inventor: Michael Mingo, Buffalo, NY (US)

(21) Appl. No.: 15/418,092

(22) Filed: Jan. 27, 2017

Related U.S. Application Data
(60) Provisional application No. 62/287,494, filed on Jan. 27, 2016.

(51) Int. Cl. A62B 23/02; A62B 18/08; A41D 13/11

(52) U.S. Cl. CPC A62B 23/025; A41D 13/1107; A41D 13/1161; A62B 18/08; A41D 2300/32

(57) ABSTRACT

A protective and thermally insulating mask useful in preventing inhalation of airborne materials and keeping a user's face, ears and neck warm. The protective mask allows the user to comfortably and conveniently wear it around the neck, yet readily position it on the face whereby it conforms to the contour of the particular user's face. The mask has a removable pocket positioned to cover the nose and mouth of a user. The pocket can accept one or more filters, depending on the needs of the user, to provide protection from airborne contaminants. The pocket is typically of the same material as the body of the mask, and is removable and can be washed or replaced as needed.

### CROSS REFERENCE OF RELATED APPLICATIONS

This application claims the benefits of U.S. provisional application no. 62/287,494, filed Jan. 27, 2016 and entitled A WASHABLE FABRIC FACE MASK WITH A COMPARTMENT FOR AN AIR FILTER which provisional application is incorporated by reference herein in its entirety.

### FIELD

This invention relates to a protective filtering mask useful in preventing inhalation of airborne materials. More particularly, the invention relates to a personalized protective mask which allows the user to conveniently wear it around the neck, yet readily position it on the face whereby it conforms to the facial features of a particular user.

### BACKGROUND

Facemasks are useful in a number of different situations, including air filtration, blocking foreign particles from contacting skin and thermal insulation. In everyday use for air filtration, face masks can be used to filter out dust or allergens, particularly in certain areas where air pollution is prevalent. In some countries it is not uncommon to see people in public wearing surgical-type face masks in public places such as airports and streets. Additionally, it is not uncommon to see people who may be ill with transmittable airborne pathogens wearing surgical masks in public under doctor's orders. The overall aesthetic effect of the use of such masks in public may be disconcerting to others and cause problems for those who wish to use such masks and those around them.

In addition to the use of face masks for air filtration, facemasks are often used in colder climates to cover a significant portion of the front, back and sides of the face and neck for comfort and in order to prevent frostbite. These facemasks may be used at sporting events, construction sites or during participation in winter sports such as skiing. However, conventional facemasks do not filter airborne contaminants.

Accordingly, there is a need for an air filtration mask that removes contaminants from the air, is aesthetically pleasing, blocks foreign particles from contacting skin or entering the ear, is comfortable and washable, and retains heat around the face and neck in colder temperatures. Further, there is a need for such a facemask to allow for replacement of the filter without discarding the entire mask.

### SUMMARY

The filtering mask of the present disclosure combines the features of a filtering mask and a thermally insulating facemask. The filtering mask can be easily pulled down from the face to serve as a neck warmer, and raised up to protect the face from cold and airborne contaminants. The generally rectangular shape provides uniform heat protection around the head or neck, which would not be possible with a standard filter mask with straps in the back.

The present disclosure describes a washable fabric face mask having a removable compartment for a nose and mouth air filter. The face mask includes a mask body portion to cover the mouth, nose and neck and has a filter pocket, or compartment, on the inner side of the mask to contain the filter. The filter is removable from the filter pocket and can be replaced once saturated from use. The filter pocket is removable from the mask body portion of the face mask. Removability of the pocket allows for replacement of the pocket should contaminants enter the pocket, thereby making it difficult to clean. Adjacent to the mask body portion are left and right extension portions, which wrap around the head of the user and attach in the back.

The extension portions are part of the mask body and cover a significant portion of the sides and back of the neck with a thermal insulating material, thereby providing a barrier to keep out toxic contaminants and keep in warmth. The extension and attachment portions may be comprised of the same material as the mask body portion and are preferably an integral portion of the mask body of the mask. Engagement of the left ear attachment member and the right ear attachment member causes the mask body portion, the left extension portion, and the right extension portion to be retained on the user.

### BRIEF DESCRIPTION OF THE DRAWINGS

FIG. 1 is a perspective rear view of the mask showing the pocket partially attached to the rear of the mask.

FIG. 2 is a perspective rear view of the mask and the interior of the pocket.

FIG. 3 is a rear view of the mask.

FIG. 4 is a perspective top view of the mask showing the pocket partially attached to the rear of the mask.

FIG. 5 is a perspective view of mask partially closed at the back.

FIG. 6 is a perspective front view of the mask with the filter partially inserted in the pocket.

FIG. 7 is a perspective rear view of the mask with the filter fully inserted in the pocket.

### DETAILED DESCRIPTION

Various features and advantages of the invention will be set forth in part in the following description, or may be obvious from the description, or may be learned from practice of the invention. Particular embodiments of the present disclosure are described hereinbelow with reference to the accompanying drawings. In the following description, well-known functions or constructions are not described in detail to avoid obscuring the present disclosure in unnecessary detail.

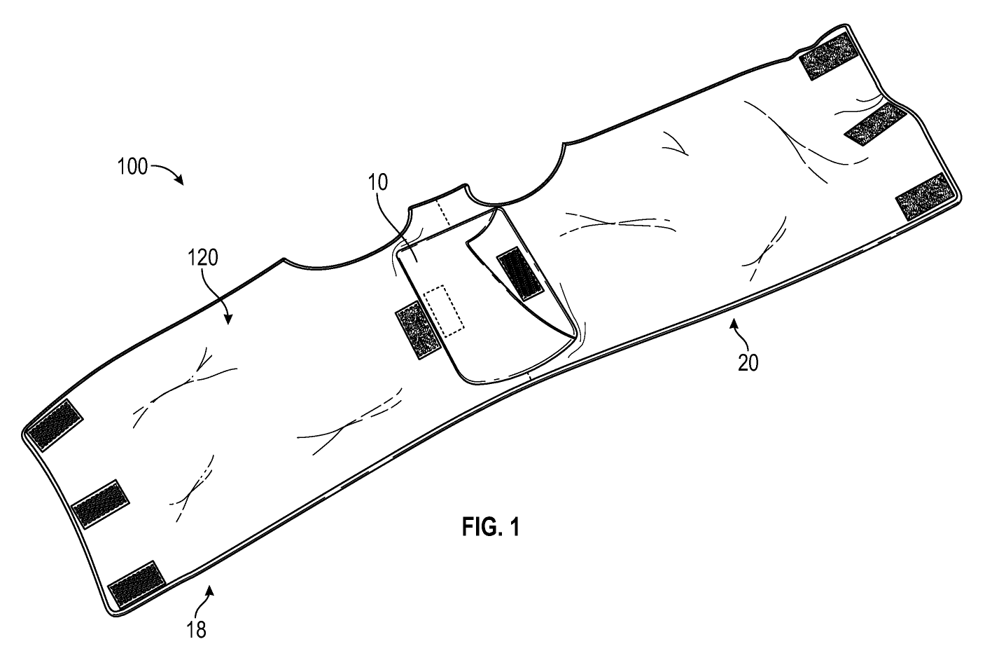

FIG. 1 designates the mask body 120 of the filtering mask 100 which overlies a user's mouth, nose, ears and neck and is comprised of a particle impervious material that is also breathable, preferably a microfiber, and is comfortable for contact with a user's skin. FIG. 1 illustrates a first extension portion 18 and a second extension portion 20 each having a suitable interengaging means of connection for holding the filtering mask 100 in applied position. The extension portions 18 and 20 cover a significant portion of the sides and back of the neck with a thermally insulating material, such as microfiber, thereby providing a barrier to keep out toxic contaminants and keep in warmth. The extension portions 18 and 20 may preferably be comprised of the same material as the mask body portion. Pocket 10 is shown removably attached to mask body 120.

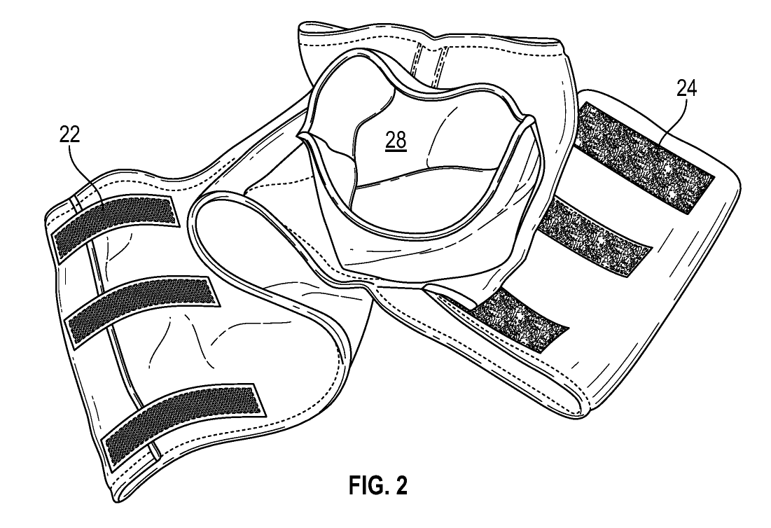

FIG. 2 shows the interengaging means which are comprised of a set of first extension hook and loop fastener strips 22, of which there are three in the preferred embodiment, and a set of second extension hook and loop fastener strips 24, of which there are three in the preferred embodiment, which adhere to the first extension portion 18 and second extension portion 20, respectively and cooperate to attach the filtering mask to a user. In FIG. 2, the first extension hook and loop fastener strip 22 and a second extension hook and loop fastener strip 24 are shown placed horizontally along the first and second extensions, however, vertical placement of the hook and loop fastener strips or angled placement of the hook and loop fastener strips are contemplated within the present disclosure.

The number of hook and loop fastener strips on the outer portions of the extensions may vary, however, in the preferred embodiment, three hook and loop fastener strips placed evenly apart on the first and second extensions toward the outer portions of each extension is preferred. Also illustrated in FIG. 2 is pocket 10 having pocket opening 28, which is shown in an open position. The margin of the mask body 10 is in close contact with the circumference of the region covering the face, neck and ears of the wearer. The mask body of the respirator is attached to pocket 10 with a removable attachment means. FIG. 2 shows a pocket opening 28 that is configured to accept a generally rectangular filter.

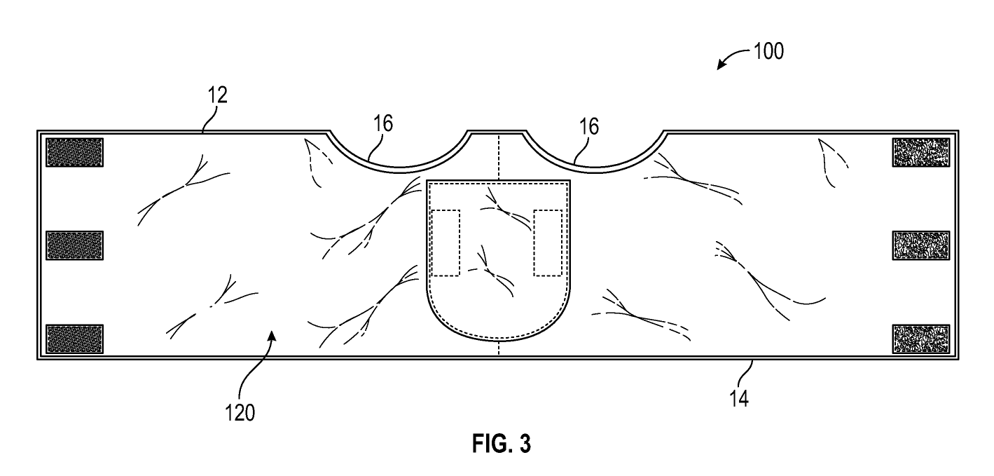

FIG. 3 illustrates filtering mask 100 which is suitably shaped to cover the user's nose and mouth, where top portion 12 and bottom portion 14 have an area between which, when filtering mask 100 is in place, covers the mouth, nose, ears and the back portion of the neck. In a preferred embodiment, the top portion 12 of the mask is in line with the center portion of the eye, except for the grooves 16 to allow unobstructed eyesight and eye movement. The top portion 12 has a generally horizontal linear edge with grooves 16 adjacent the upper portion of the nose, on either side, that form cutouts for portions of the eye including eyelids and eyelashes; whereas bottom portion 14 has a generally horizontal linear edge. In a preferred embodiment, the lower edge of the bottom portion of the mask body extends around the head just below the mouth in a horizontal linear fashion around the head.

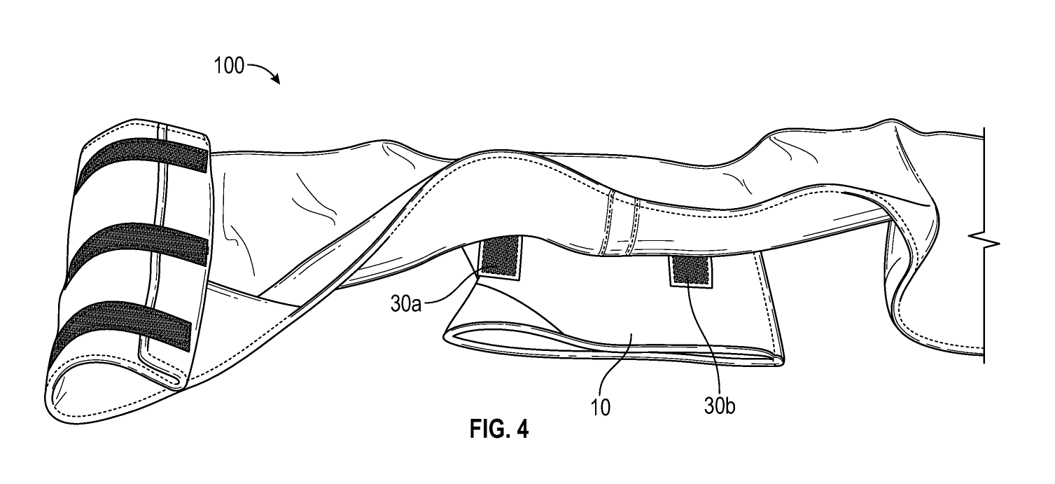

FIG. 4 shows pocket 10 partially attached to the mask body 120 with pocket hook and loop attachment strips 30a and 30b. The pocket hook and loop attachment strips are placed on the sides of the pocket 10 on the interior portion, where the will not interfere with or contact the mouth and nose. Pocket 10 is removable to allow for ease of replacement of the filter and ease of washing after use. While pocket 10 and mask body 120 may be preferably formed of microfiber, similar washable and breathable fabric may be used.

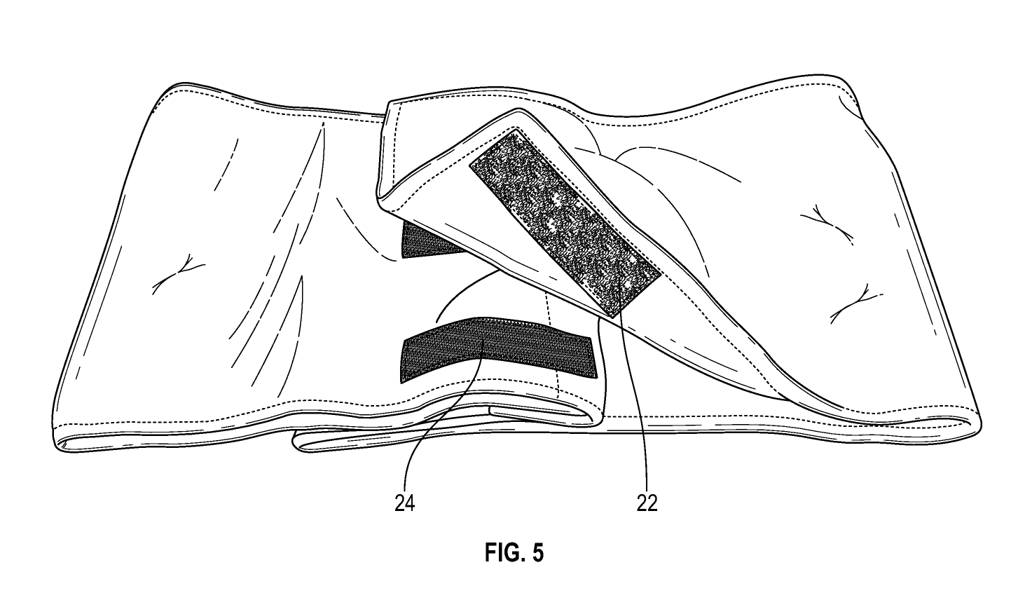

FIG. 5 shows the rear portion of filtering mask 100. Here, interengaging means which, in a preferred embodiment, are comprised of a first extension hook and loop fastener strip 22 and a second extension hook and loop fastener strip 24 are shown partially attached in a location that would be behind a user's head on the neck when worn. In alternative embodiments the mask could be elastic and therefore require no interengaging means behind the user's head and could slide into place over the head and held in place by pressure from the elastic. Alternatively, mechanical or other means of closure as would be known to one of ordinary skill in the art could be employed to close the region of the extension that lie behind a user's head when in place.

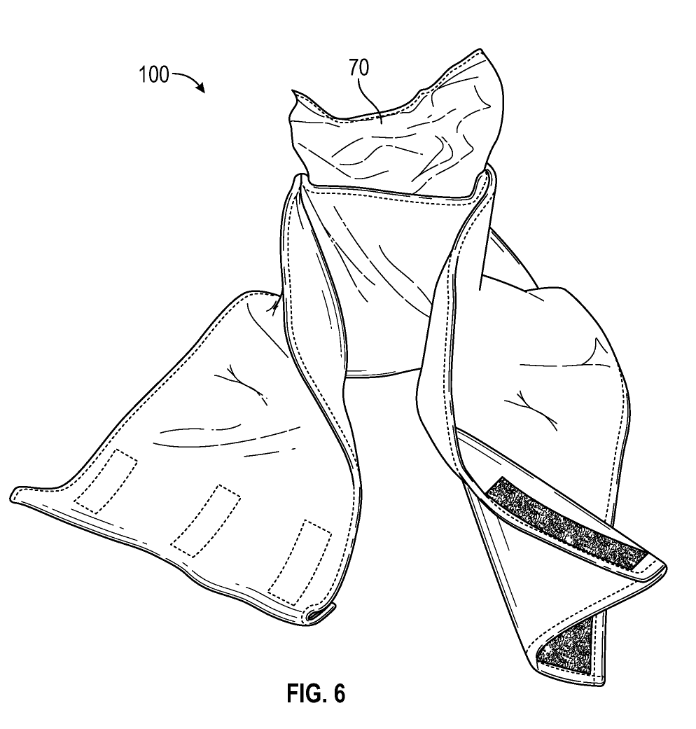

FIG. 6 shows filtering mask 100 having a filter pocket 10 removably attached to the inner side of the mask to contain the filter 70, here shown partially inserted into pocket 10. The filter 70 is removable from pocket 10 and can be replaced once saturated from use. Multiple filters 70 can be placed side by side and inserted into pocket 10 for additional protection. Pocket 10 is removable from the mask body 120 of the filtering mask 100.

Filters may preferably be Material T-150 filters, manufactured by Nelson Laboratories in Rochester, NY, which are comprised of a white blended synthetic, white spunbond polypropylene microfiber. The Material T-150 filters have an air permeability of >200CFM. The scrim weight is 15g/m2. The filters may be thin, such that they may be stacked side by side, i.e. horizontally, inside pocket 10 wherein each filter 70 is placed in the pocket 10 in a vertical plane, the number of filters 70 depending on the extent of filtering needed by the user. For example, one filter 70 may be sufficient for cutting grass, while two filters 70 may be stacked in a tiered formation during drywall installation.

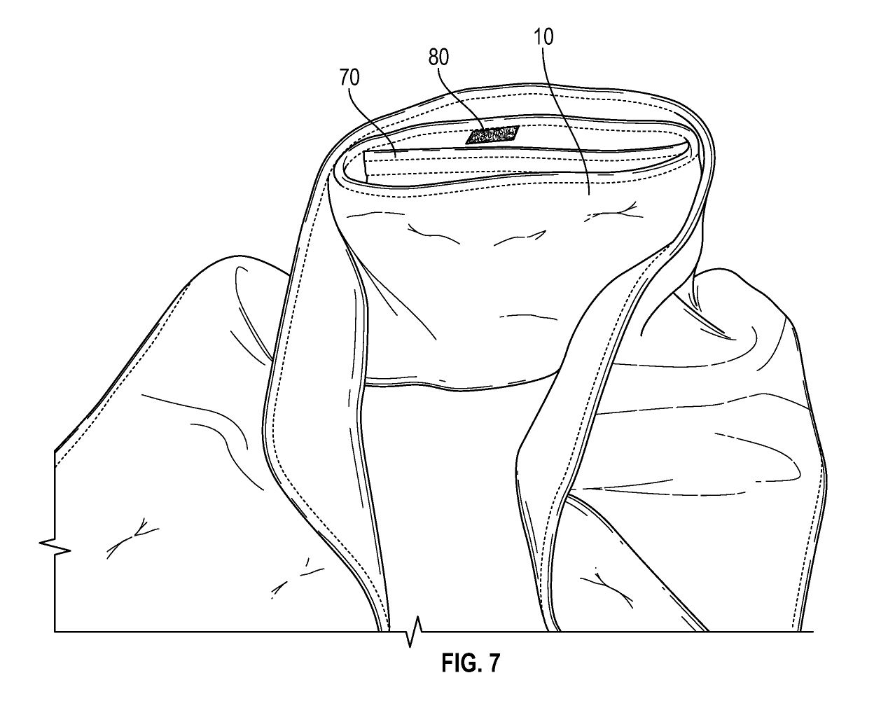

FIG. 7 shows filter 70 fully inserted into pocket 10, wherein pocket 10 has a top pocket hook and loop fastener 80 to hold filter 10 in place with the corresponding hook and loop fastener on the adjacent side inside the top of pocket 10.

While preferred embodiments of this disclosure has been described above and shown in the accompanying drawings, it should be understood that applicant does not intend to be limited to the particular details described above and illustrated in the accompanying drawings, but intends to be limited only to the scope of the disclosure as defined by the following claims. In this regard, the term “configured” as used in the claims is intended to include not only the designs illustrated in the drawings of this application and the equivalent designs discussed in the text, but it is also intended to cover other equivalents now known to those skilled in the art, or those equivalents which may become known to those skilled in the art in the future.

What is claimed is:

1. A filtering mask comprising:
a mask body comprising a reusable, washable fabric, wherein the mask body overlies at least a portion of a mouth, nose, ears and neck of the user; the mask body capable of receiving a pocket; wherein the pocket is removably attached to the mask body; wherein the pocket comprises a reusable, washable and breathable material and is configured to receive and support at least one filter; wherein the at least one filter is capable of being removably held by the pocket to overlying at least the mouth and nose of the user.

2. The filtering mask of claim 1, wherein the pocket removably attached to an inner portion of the mask body.

3. The filtering mask of claim 1, wherein the pocket has an opening on a top side configured to receive the at least one filter.

4. The filtering mask of claim 1, wherein the mask body is comprised of a thermally insulating material and is configured to be thermally insulating to a user's ears, neck, nose, mouth and chin.

5. The filtering mask of claim 1, wherein the holder comprises a microfiber material.

6. The filtering mask of claim 1, wherein the holder is constructed to hold the filter article in a selected location.

7. The filtering mask of claim 1, wherein the pocket comprises a first fastening material and the mask body comprises a second fastening material that cooperatively engages the first fastening material and enables the pocket to be removably affixed to the holder.

8. The filtering mask of claim 7, wherein the first and second fastening materials comprise mechanical fastening material.

9. The filtering mask of claim 1, wherein the filter article is disposable.

10. The filtering mask of claim 1, wherein the pocket is removably affixed to the mask body.

11. The filtering mask of claim 1, wherein the pocket is removably affixed to the mask body using a hook and loop fastener.

12. The filtering mask of claim 1, wherein the pocket comprises at least two cooperating fastening materials affixed to opposed surfaces of the mask body that can be positioned to removably cover the user's mouth and nose.

13. The filtering mask of claim 1, wherein the at least one filter at least partially removes airborne contaminants.

14. The filtering mask of claim 1, wherein a plurality of filters are stacked in a horizontal direction to provide increased filtration.

15. The filtering mask of claim 1, wherein the material comprising the mask body is the same as the material comprising the pocket.

16. The filtering mask of claim 1, wherein the mask body is generally rectangular.

17. The filtering mask of claim 1, wherein the mask body has grooves in a top portion adjacent the pocket.

18. A filtering mask comprising:
a mask body comprising a reusable, washable, thermally insulating fabric, wherein the mask body overlies at least a portion of a user's head, including a user's mouth, nose and ears; the mask body having a pocket; wherein the pocket comprises a reusable, washable and breathable material and is configured to receive and support at least one filter; wherein the at least one filter is capable of being removably held by the pocket to cover a user's mouth and nose.

19. The filtering mask of claim 18, wherein the pocket is removable from the mask body.

20. A filtering mask comprising:
a mask body comprising a generally rectangular, reusable, washable, breathable, thermally insulating microfiber fabric having grooves in a top portion to allow for unobstructed vision; the mask body capable of removably attaching at least one pocket over a user's mouth and nose, said pocket being removably attached to the mask body with vertically aligned hook and loop fastener strips on each side; the pocket capable of receiving and supporting at least one filter; wherein the pocket is replaceable; a pocket opening being on a top portion of the pocket, wherein the pocket opening is capable of being closed with a hook and loop fastener; wherein the pocket comprises the reusable, washable and breathable material of the mask body; the at least one filter capable of being removably held in close bodily contact by said pocket over the user's mouth and nose.
